(19) United States
(12) Patent Application Publication
(10) Pub. No.: US 2003/0056435 A1
(43) Pub. Date: Mar. 27, 2003

(54) Cat baffle

(76) Inventor: Theresa L. Adjan-Vallen, Norwell, MA (US)

Correspondence Address: John P. McGonagle, Law Offices of John P. McGonagle, 800 Hingham Street - 2N, Rockland, MA, 02370, US

(21) Appl. No.: 09/961,566

(22) Filed: Sep. 24, 2001

(51) Int. Cl. A01G 1/00

(52) U.S. Cl. 47/33

(57) ABSTRACT

A number of vertically upright, thin, wire mesh sections are interconnected and arranged in a circle with spokes about a bird feeder pole over a desired ground area beneath the pole. The wire sections are smooth on top with no upwardly directed sharp pieces. The wire section arrangement prevents a cat from having a stable area to sit on.

### BACKGROUND OF THE INVENTION

The present invention relates to animal deterrent devices, and in particular to a device for deterring cats from approaching an area protected by the device.

Cats are known to prey on birds feeding from post-mounted bird feeders. The prior art discloses various obstacle devices which may be mounted on the post of a bird feeder to prevent an animal from climbing up to the bird feeding area. However, since a cat can jump over six feet into the air, it may still be able to clear the obstacle and reach the bird feeding area. Even if the cat can not reach the bird feeding area, it can still catch a bird by waiting on the ground area near a bird feeder post or below a bird feeder. By sitting on the ground area beneath the feeder, a cat can jump and catch a bird hovering near the bird feeder or can catch a bird dropping to the ground to retrieve food which has fallen from the bird feeder.

Some attempts have made in the prior art to protect a selected ground area. Those that might discourage a cat usually have vertical, sharpened spikes which are affixed to some type of mat device. Although these types of devices may have a certain effectiveness, they are unsightly, and dangerous to people, especially children.

### SUMMARY OF THE INVENTION

The present invention overcomes the limitations of the prior art, by providing a number of vertically upright, thin, wire mesh sections which are interconnected. The wire sections are arranged below a bird feeder or about a bird feeder pole over a desired ground area beneath the bird feeder. The wire sections are smooth on top with no upwardly directed sharp pieces. The sections are typically made a dark green in color. The color and thinness of the wire sections make the present invention nearly invisible from any distance. The wire section arrangement prevents a cat from having a stable area to sit on. A cat must sit and be comfortable in order to pounce. Without a clear landing area, a cat will not jump over the outer wire sections to get onto the area beneath a bird feeder.

These together with other objects of the invention, along with various features of novelty which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

FIG. 1 is a perspective view of one embodiment of the invention.

FIG. 2 is a front view of the invention folded.

FIG. 3 is a top view of the invention embodiment shown in FIG. 1.

FIG. 4 is a top view of another embodiment of the invention.

FIG. 5 is a top view of still another embodiment of the invention.

FIG. 6 is a front view of a wire section as used in the embodiment shown in FIGS. 1-3.

FIG. 7 is a front view of a wire section as used in the embodiment shown in FIG. 4.

FIG. 8 is a front view of a wire section as used in the embodiment shown in FIG. 5.

### DETAILED DESCRIPTION OF THE INVENTION

Referring to the drawings in detail wherein like elements are indicated by like numerals, the present invention 1 is comprised of a number of interconnected wire sections 10, each of which is comprised of a main inverted U-shaped section 11 having an outer elongated leg 12, a parallel inner elongated leg 13 and a rounded top 20 interconnecting both legs 12, 13. The outer leg 12 has a vertical bottom 15 and a vertical top 14 terminating in a generally horizontal end 21 of the rounded top 20. The inner leg 13 has a vertical bottom 17 and a vertical top 16 terminating in a generally horizontal end 22 of the rounded top 20.

Each section 10 is further comprised of two cross bars, an upper cross bar 30 and a lower, parallel cross bar 31. The upper cross bar 30 has two ends, an outer end 32 connected to the outer vertical leg 12 and an inner end 33 protruding past the inner leg 13. The upper cross bar inner end 33 terminates in a hook 34. The upper cross bar 30 is connected to the inner leg 13 at the point 35 where the upper cross bar 30 crosses the inner leg 13. The lower cross bar 31 also has two ends, an outer end 36 connected to the vertical outer leg 12 and an inner end 37 protruding past the vertical inner leg 13. The lower cross bar inner end 37 terminates in a hook 38. The lower cross bar 31 is connected to the inner leg 13 at the point 39 where the lower cross bar 30 crosses the inner leg 13.

Each wire section 10 is further comprised of inverted U-shaped reinforcing section 40 having an outer elongated leg 41, a parallel inner elongated leg 42 and a rounded top 50 interconnecting both legs 41, 42. The outer leg 41 has a vertical bottom 43 and a vertical top 44 terminating in a generally horizontal end 51 of the rounded top 20. The inner leg 42 has a vertical bottom 45 and a vertical top 46 terminating in a generally horizontal end 52 of the rounded top 50. The outer leg bottom 43 and inner leg bottom 45 each terminate at and are joined to the lower cross bar 31. The outer leg 41 and inner leg 42 are further joined to the upper cross bar 30 near to each leg's top 44, 46. The reinforcing section top 50 is positioned below the main section top 20.

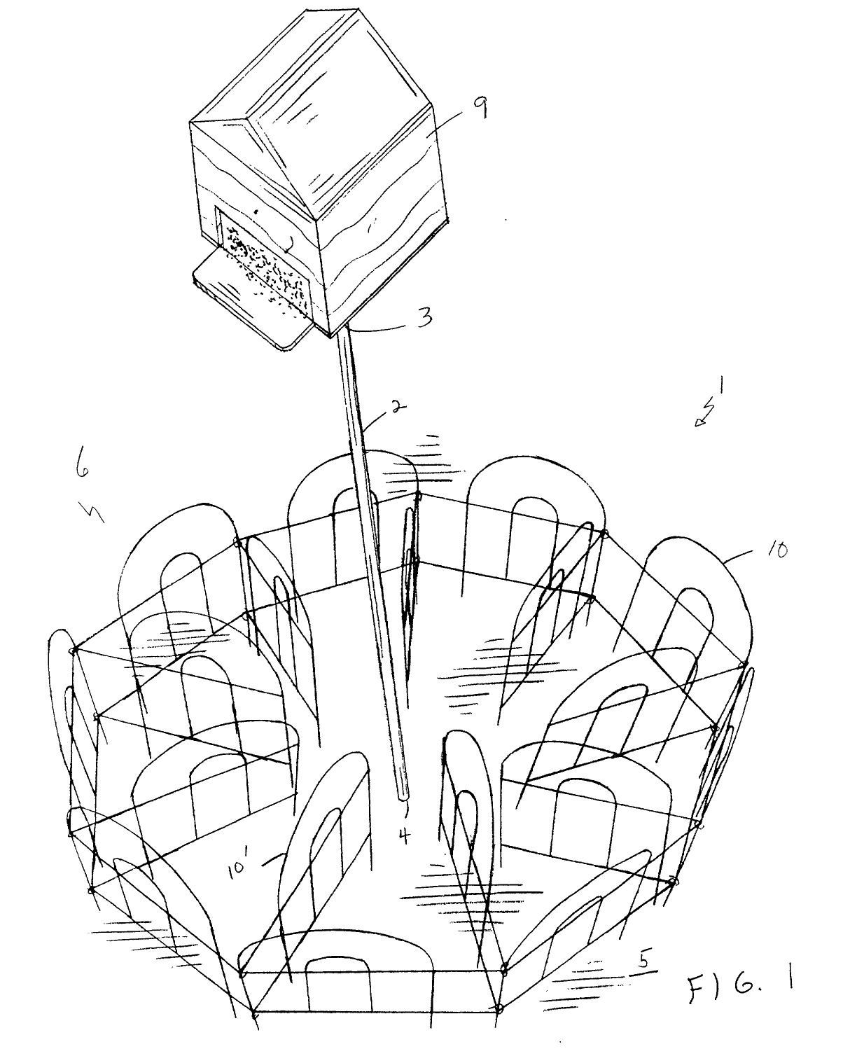

Referring particularly to FIGS. 1 and 3, the invention 1 is comprised of a number of sections 10 assembled into an approximate circle 6 around a vertical bird feeder pole 2. The invention 1 may also be used beneath a bird feeder hanging without a pole. In the embodiment shown, the pole 2 has two ends, an upper end 3 supporting a bird feeder 9 and a lower end 4 inserted into the ground 5. In this embodiment of the invention, nine sections form the circle 6. To form the circle 6, the cross bar hooks 34, 38 of one section 10 are fitted about the vertical outer leg 12 of an adjacent section. The outer and inner leg bottoms 15, 17 of each section 10 are inserted into the ground 5. The invention 1 is further comprised of nine additional sections 10′ arranged within the circle 6, much like spokes in a wheel. The cross bar hooks 34, 38 of each “spoke” section 10′ is connected to a vertical outer leg 12 of a circle section 10. The “spoke” section outer legs 12 are positioned near to or adjacent to the pole 2. The “spoke” section outer and inner leg bottoms 15, 17 are inserted into the ground 5 for stability of the entire arrangement.

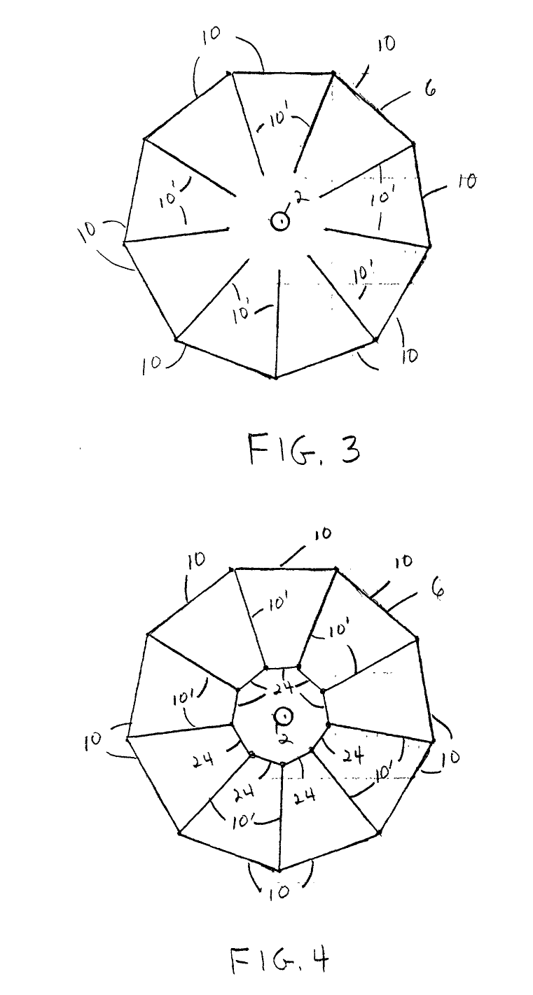

For additional stability, the outer legs 12 of each “spoke” section 10′ may have one or more elongated connector elements 24 attached thereto. Each connector element 24 has an end 25 pivotally attached to an outer leg 12. The connector element 24 has an opposite end terminating in a hook 26. The connector element 24 is attached to an adjacent “spoke” section 10′ by attachment of the connector hook 26 to the adjacent section outer leg 12. See FIGS. 4 and 7.

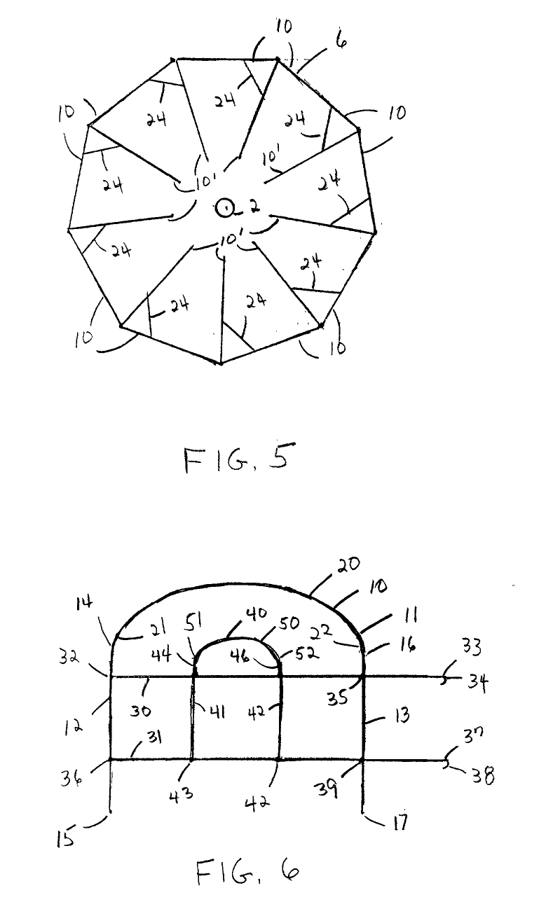

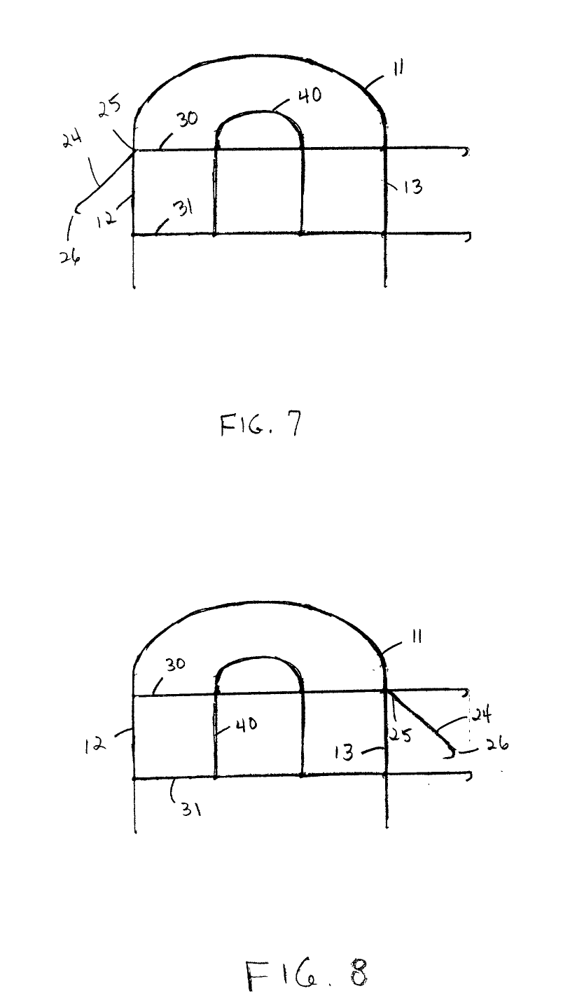

In another embodiment for adding stability, the inner legs 13 of each “spoke” section 10′ may have one or more elongated connector elements 24 attached thereto. Each connector element 24 has an end 25 pivotally attached to an inner leg 13. The connector element 24 has an opposite end terminating in a hook 26. The connector element 24 is attached to an adjacent “spoke” section 10′ by attachment of the connector hook 26 to the adjacent section reinforcing outer leg 41. See FIGS. 5 and 8.

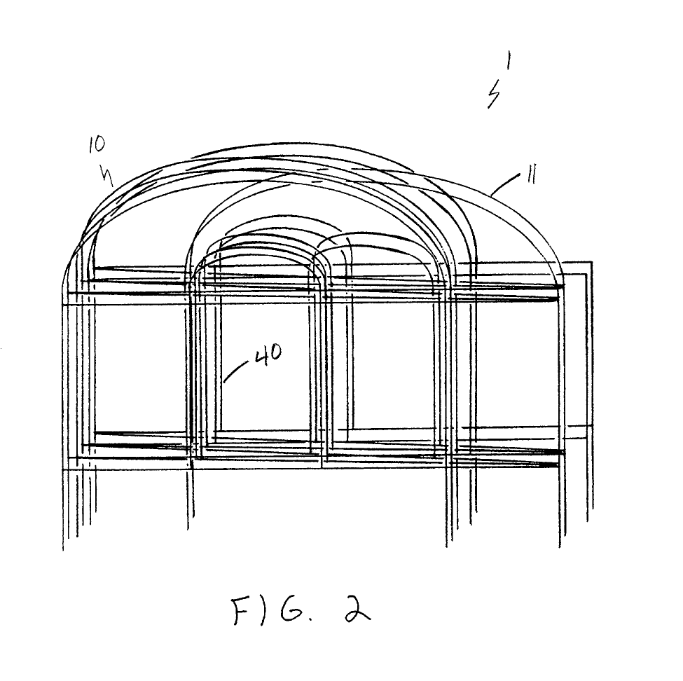

The present invention will deter cats from the area about the bird feeder pole 2 or beneath a hanging bird feeder. Applicant has found that a cat will not go into the area surrounded by the invention circle 6. Nor will a cat jump the circle wire sections 10 without a clear landing area. The invention “spoke” sections 10′ eliminate a clear landing area. The circle sections 10 and “spoke” sections 10′ prevent a cat from setting itself comfortably to pounce after a bird. The invention cat baffle 1 does not have any upwardly pointing sharp ends, thereby providing feeding birds perches on which to set in order to recover seed and the like which may have fallen from the bird feeder 9. The thinness of the wire used in the wire sections 10, 10′ prevents squirrels from having a stable platform from which to leap up to the bird feeder 9. In the preferred embodiment, the present invention 1 is made entirely from a thin wire, and is painted a dark green. This makes the invention 1 nearly invisible against a normal vegetation and grass environment. As may be seen most clearly from FIG. 2, the invention 1 may be easily folded for carrying, storage or shipping.

It is understood that the above-described embodiment is merely illustrative of the application. The basic teachings of the present invention have been described above. Many extensions and variations will be obvious to one having ordinary skill in the art. Many, if not all of the physical aspects of the game are flexible, i.e., number of elements, element composition, spaces, dimensions, colors, etc. Other embodiments may be readily devised by those skilled in the art which will embody the principles of the invention and fall within the spirit and scope thereof.

I claim:

1. In combination with a bird feeder suspended above an area of ground, a cat baffle comprising:
a plurality of interconnected wire sections, each of which is comprised of a main inverted U-shaped section having an outer elongated leg, a parallel inner elongated leg and a rounded top interconnecting both legs, said outer leg having a vertical bottom and a vertical top terminating in a generally horizontal end of the rounded top, said inner leg having a vertical bottom and a vertical top terminating in a generally horizontal end of the rounded top.

2. A cat baffle as recited in claim 1, wherein:
each section is further comprised of a plurality of cross bars, one of which is an uppermost cross bar and a another of which is a lowermost, parallel cross bar, said uppermost cross bar having two ends, an outer end connected to the outer vertical leg and an inner end protruding past the inner leg, said inner end terminating in a hook, said uppermost cross bar being connected to the inner leg at a point where the uppermost cross bar crosses the inner leg, said lowermost cross bar having two ends, an outer end connected to the vertical outer leg and an inner end protruding past the vertical inner leg, said lowermost cross bar inner end terminating in a hook, said lowermost cross bar being connected to the inner leg at a point where the lower cross bar crosses the inner leg.

3. A cat baffle as recited in claim 2, wherein:
each wire section is further comprised of an inverted U-shaped reinforcing section having an outer elongated leg, a parallel inner elongated leg and a rounded top interconnecting both legs, said reinforcing section outer leg having a vertical bottom and a vertical top terminating in a generally horizontal end of the reinforcing section rounded top, said reinforcing section inner leg having a vertical bottom and a vertical top terminating in a generally horizontal end of the rounded top, said reinforcing section outer leg bottom and inner leg bottom each terminating at and are joined to the lower cross bar, said reinforcing section outer leg and inner leg being further joined to the upper cross bar near to each reinforcing section leg's top, said reinforcing section top being positioned below the main section top.

4. A cat baffle as recited in claim 3, wherein:
a designated number of said interconnected sections are assembled into an approximate circle about said area of ground, wherein the cross bar hooks of one section are fitted about the vertical outer leg of an adjacent section, said outer and inner leg bottoms of each section being inserted into the ground;
a designated number of said interconnected sections are arranged within the circle as spokes, wherein the cross bar hooks of each spoke section are connected to a vertical outer leg of a circle section, said spoke section outer legs being positioned near to or adjacent to a center of the circle, said spoke section outer and inner leg bottoms being inserted into the ground.

5. A cat baffle as recited in claim 4, wherein:
the outer legs of each spoke section each have a plurality of elongated connector elements attached thereto, each connector element having an end pivotally attached to an outer leg, said connector element having an opposite end terminating in a hook, said connector element being attached to an adjacent spoke section by attachment of the connector hook to the adjacent section outer leg.

6. A cat baffle as recited in claim 4, wherein:
the inner legs of each spoke section have a plurality of elongated connector elements attached thereto, each connector element having an end pivotally attached to an inner leg, said connector element having an opposite end terminating in a hook, said connector element being attached to an adjacent spoke section by attachment of the connector hook to the adjacent section reinforcing outer leg.
